(19) United States
(12) Patent Application Publication
(10) Pub. No.: US 2013/0095454 A1
(43) Pub. Date: Apr. 18, 2013

(54) APPARATUS AND METHOD FOR INPUTTING BRAILLE IN A PORTABLE TERMINAL

(71) Applicant: Samsung Electronics Co., Ltd., Gyeonggi-do (KR)

(72) Inventor: Chang-Hyup JWA, Jeju-si (KR)

(73) Assignee: Samsung Electronics Co., Ltd., Gyeonggi-do (KR)

(21) Appl. No.: 13/652,938

(22) Filed: Oct. 16, 2012

(30) Foreign Application Priority Data
Oct. 17, 2011 (KR) 10-2011-0105966

(51) Int. Cl. G09B 21/02

(52) U.S. Cl. 434/113

(57) ABSTRACT

An apparatus and method are provided for inputting braille in a portable terminal. The apparatus includes an input unit including an input button for receiving an input from a user; and a control unit for determining a dot position of a braille input unit based on the input from the user.

### PRIORITY

The present application claims priority under 35 U.S.C. §119 to Korean Application Serial No. 10-2011-0105966, which was filed in the Korean Intellectual Property Office on Oct. 17, 2011, the content of which is incorporated herein by reference.

### BACKGROUND OF THE INVENTION

1. Field of the Invention

The present invention relates generally to a keypad of a portable terminal for the visually impaired, and in particular, to an apparatus and method for improving braille input performance by using direction keys.

2. Description of the Related Art

In general, portable terminals for visually impaired users include keypads having key buttons that that include characters representing functions allocated to respective key buttons expressed by international standard braille.

However, conventional keypads of portable terminals for the visually impaired express braille using protrusions within a narrow space on key buttons. Therefore, because the intervals between protrusions are often too small, it is difficult to recognize braille.

In addition, newer conventional portable terminals may express content of a received message using a vibration generation function (namely, express braille through vibrations) and allow a user to directly create text through handwriting, instead of using a keypad. However, expressing message content using vibrations cannot be applied to inputting characters by the user, and a character recognition rate when creating text through handwriting is low.

### SUMMARY OF THE INVENTION

The present invention has been made to address at least the above-described problems occurring in the prior art, and to provide at least the advantages described below.

Accordingly, an aspect of the present invention is to provide an apparatus and method for improving braille input performance in a portable terminal.

Another aspect of the present invention is to provide an apparatus and method for inputting braille using direction keys in a portable terminal.

Another aspect of the present invention is to provide an apparatus and method that simplify a procedure for inputting braille in a portable terminal.

In accordance with an aspect of the present invention, an apparatus for inputting braille in a portable terminal is provided. The apparatus includes an input unit including an input button for receiving an input from a user; and a control unit for determining a dot position of a braille input unit based on the input from the user.

In accordance with another aspect of the present invention, a method for inputting braille in a portable terminal is provided. The method includes receiving an input from a user; and determining a dot position of a braille input unit, based on the input from the user.

In accordance with another aspect of the present invention, an electronic device for inputting braille is provided. The electronic device includes a non-transitory machine-readable medium storing one or more programs which when executed implement the steps of receiving an input from a user; and determining a dot position of a braille input unit, based on the input from the user.

### BRIEF DESCRIPTION OF THE DRAWINGS

The above and other aspects, features, and advantages of certain embodiments of the present invention will become more apparent from the following detailed description when taken in conjunction with the accompanying drawings in which:

FIG. 1 is a block diagram illustrating a portable terminal for inputting braille according to an embodiment of the present invention;

FIG. 2 is a flow chart illustrating a braille input method in a portable terminal according to an embodiment of the present invention;

FIG. 3 is a flow chart illustrating a braille input method in a portable terminal according to an embodiment of the present invention;

FIGS. 4A to 4D illustrate a sequential braille input process in a portable terminal according to an embodiment of the present invention;

FIGS. 5A and 5B illustrating a process of inputting braille in a portable terminal according to an embodiment of the present invention;

FIG. 6A is a diagram illustrating a braille table with respect to the English alphabet according to an embodiment of the present invention;

FIG. 6B is a diagram illustrating a braille table with respect to Hangul and numbers according to an embodiment of the present invention;

FIGS. 7A to 7C illustrate a process of inputting braille in a portable terminal according to an embodiment of the present invention; and

FIGS. 8A and 8B illustrating a process of inputting braille in a portable terminal according to an embodiment of the present invention.

### DETAILED DESCRIPTION OF EMBODIMENTS OF THE INVENTION

Various embodiments of the present invention will be described herein below with reference to the accompanying drawings. In the following description, detailed descriptions of well-known functions or configurations will be omitted since they would unnecessarily obscure the subject matters of the present invention.

In accordance with an embodiment of the present invention, an apparatus and method are provided for improving braille input performance in a portable terminal, wherein a user inputs braille using direction keys. Herein, direction keys may be a portion of a keyboard included in a portable terminal, such as a keyboard of a mobile communication terminal. In addition, the portable terminal refers to a portable electronic device. Examples of the portable terminal include a mobile phone, a media player, a tablet computer, a handheld computer, a Personal Digital Assistant (PDA), etc. Also, the portable terminal may be a portable electronic device including a device having a combination of two or more functions of such devices.

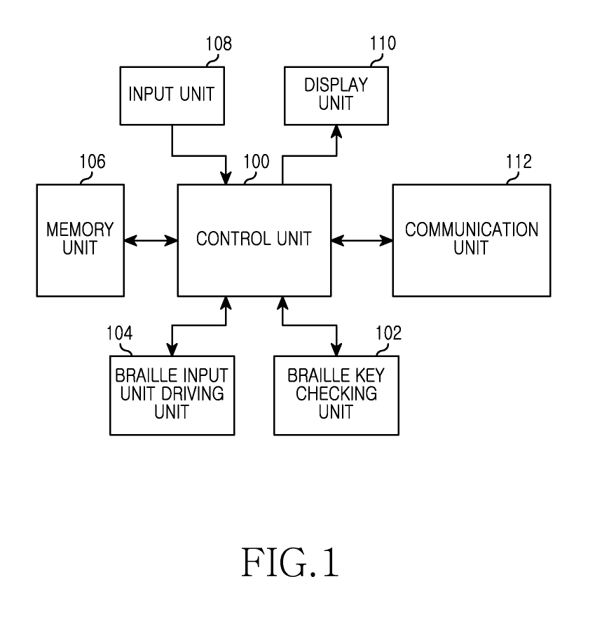

FIG. 1 is a block diagram illustrating a portable terminal for inputting braille according to an embodiment of the present invention.

Referring to FIG. 1, the portable terminal includes a control unit 100, a braille key checking unit 102, a braille input unit driving unit 104, a memory unit 106, an input unit 108, a display unit 110, and a communication unit 112. Herein, the term “unit” refers to a device or a combination of a device and software.

The control unit 100 of the portable terminal controls an overall operation of the portable terminal. For example, the control unit 100 performs general functions, such as processing and controlling for a voice call and data communication. In addition to the general functions, the control unit 100 senses a direction key selected by a user to select a dot of a braille input unit, detects a dot position of the braille input unit to check braille input by a user. Herein, the braille input unit converts the user's braille input into a character, e.g., using a braille table including six dots that represent characters. Also, when braille recognition is completed, the control unit 100 notifies the user of a braille input state to inform about a user's braille input situation.

The braille key checking unit 102 detects the dot position of the braille input unit corresponding to the direction key input by the user under the control of the control unit 100 and provides the detected dot position to the control unit 100. Specifically, the braille key checking unit 102 senses the input of the direction key to detect a position of a dot selected by the user, a position of a dot desired to be cancelled, and a column in which the user wants to input a dot, among the six dots in the braille input unit.

The braille input unit driving unit 104 drives the braille table including the six dots to check the position of the dot corresponding to the direction key under the control of the control unit 100. In addition, when selecting the dot position by the user is terminated, the braille input unit driving unit 104 checks characters corresponding to the braille that has been input by the user and provides the checked characters to the control unit 100.

Additionally, the operations of the control unit 100, the braille key checking unit 102, and the braille input unit driving unit 104 may be executed by a software module (a command language set) stored in the memory unit 106.

The memory unit 106 includes a Read Only Memory (ROM), a Random Access Memory (RAM), and a flash ROM. The ROM stores various reference data and microcodes of programs for processing and controlling the control unit 100, the braille key checking unit 102, and the braille input unit driving unit 104.

The RAM is a working memory of the control unit 100, and stores temporary data generated during the execution of various programs. The flash ROM stores various updatable data, such as a phone book, outgoing messages, incoming messages, etc. According to an embodiment of the present invention, the flash ROM stores an international standard braille table corresponding to the English alphabet, Hangul, numbers, etc.

Additionally, the memory unit 106 stores a software module for performing operations of the control unit 100, the braille key checking unit 102, and the braille input unit driving unit 104.

The input unit 108 includes numeric keys of digits 0-9 and a plurality of function keys, such as a Menu key, a Cancel (Delete) key, a Confirmation (OK) key, a Talk (Call) key, an End key, an Internet connection key, Navigation keys (or Direction keys), and character input keys. The input unit 108 provides the control unit 100 with key input data that corresponds to a key pressed by the user. In addition, the input unit 108 includes a direction key for braille input (i.e., a direction key for selecting a dot position) to provide the control unit 100 with a position of a dot selected by the user to.

The display unit 110 displays status information, characters, videos, and still images generated while the portable terminal is in operation. For example, the display unit 110 includes a color Liquid Crystal Display (LCD), an Active-Matrix Organic Light-Emitting Diode (AMOLED), etc. Additionally, the display unit 110 may include a touch input device, i.e., a touch screen, which may be used as an input device.

The communication unit 112 transmits and receives Radio Frequency (RF) signals inputted and outputted through an antenna (not illustrated). For example, in a transmitting (TX) mode, the communication unit 112 channel-encodes, spreads, and RF-processes TX data prior to transmission. In a receiving (RX) mode, the communication unit 112 converts a received RF signal into a baseband signal and despreads and channel-decodes the baseband signal to restore original data.

Although illustrated as separate devices, the functions of the braille key checking unit 102 and the braille input unit driving unit 104 may be performed by the control unit 100 of the portable terminal. For example, the control unit 100 may be configured to process all of the functions of the braille key checking unit 102 and the braille input unit driving unit 104.

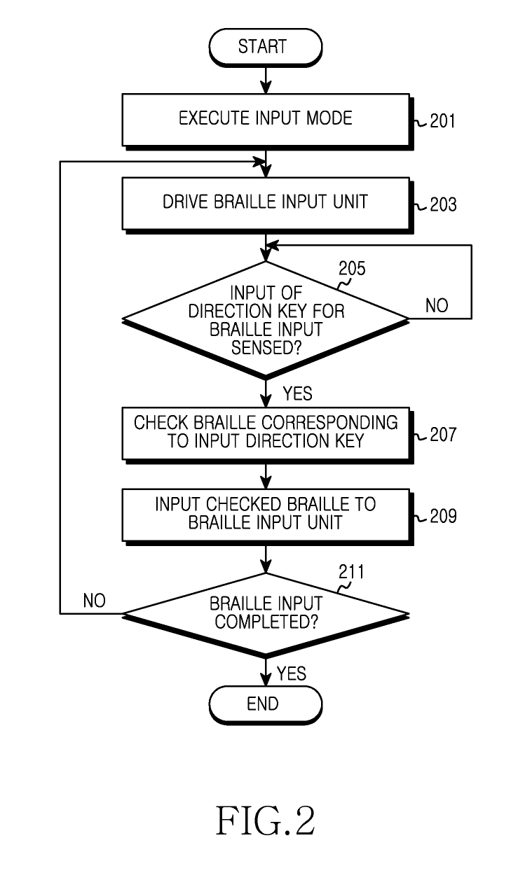

FIG. 2 is a flow chart illustrating a braille input method in a portable terminal according to an embodiment of the present invention.

Referring to FIG. 2, the portable terminal executes an input mode in step 201. Herein, the input mode refers to a mode in which Hangul (consonants, vowels), numbers, the English alphabet, and punctuation and symbols (e.g., ″, ?, ˜, etc.) are input.

In step 203, the portable terminal drives the braille input unit, such that the braille input unit converts braille input by the user into a character, e.g., using a braille table including six dots representing characters.

In step 205, the portable terminal determines whether an input of a direction key for inputting braille is sensed. Herein, a direction key for inputting braille refers to a key for determining a position of braille desired to be selected by the user from the braille table, which may be an up, a down, a left, or a right key on the portable terminal or on a keyboard.

In addition, the direction key for inputting braille may be used to define keys on a keyboard as braille positions. For example, direction keys may be used to define keys 1, 2, 3, 4, 5, and 6 as braille positions, or define a key ‘A’ as a left shift key, ‘W’ as an up shift key, ‘D’ as a right shift key, and ‘S’ as a down shift key. Namely, the direction keys may be implemented by using a plurality of methods for selecting dot positions in the braille table.

Upon sensing an input of the direction key for inputting braille in step 205, the portable terminal checks braille corresponding to the input direction key in step 207, and inputs the checked braille to the braille input unit in step 209.

In step 211, the portable terminal checks whether the braille inputting has been completed.

When braille inputting has not been completed in step 211, the portable terminal returns to step 203 to continue the braille inputting process. However, when the braille inputting has been completed, the method ends.

The method performed according to FIG. 2 may be provided as one or more instructions in one or more software modules stored in the storage unit. In that case, the software modules may be executed by the control unit 100.

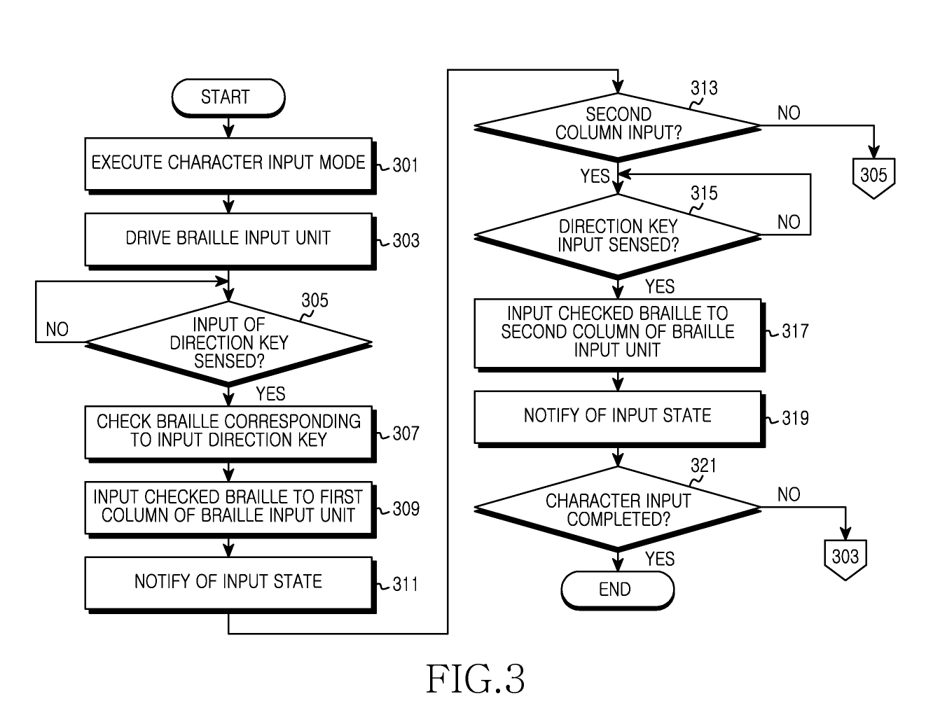

FIG. 3 is a flow chart illustrating a braille input method in a portable terminal according to an embodiment of the present invention.

Referring to FIG. 3, the portable terminal executes a character input mode in step 301. Herein, the character input mode, i.e., a mode using braille, may be a Short Message Service (SMS) creation mode, a Multimedia Message Service (MMS) creation mode, an e-mail creation mode, a messenger mode, a memo creation mode, etc.

In step 303, the portable terminal drives the braille input unit. Herein, the braille input unit converts a user's braille input into characters, e.g., using a braille table including six dots for representing characters.

In step 305, the portable terminal checks whether an input of a direction key for inputting braille is sensed. Herein, the direction key for inputting braille refers to a key for determining a position of braille desired to be selected by the user among the dots in the braille table, which may be an up, down, left, or right key on the portable terminal or the keyboard. The braille input unit includes two columns, each of which includes three dots for braille representation. Thus, the up direction key selects an upper dot in the first column or the second column, and the left direction key selects a middle dot in the first column or the second column. Also, the down direction key selects a lower dot in the first column or the second column, and the right direction key is used to change a column for a dot selection.

Upon sensing an input of a direction key for inputting braille in step 305, the portable terminal checks a dot corresponding to the input direction key in step 307, and then inputs a checked dot to the first column of the braille input unit in step 309. When a plurality of direction keys may be input subsequently in step 307, the corresponding dots are checked and the checked dots are input to the first column according to direction keys.

In step 311, the portable terminal performs an input state notification process to inform the user about a position of the dot or positions of the dots selected. For example, the portable terminal may provide a number corresponding to the position of the selected dot or the positions of the selected dots by voice or vibration.

When using vibrations for the input state notification process, the number of vibrations is minimized to reduce power consumption, and in order to provide fast feedback, different vibrations are not generated for each direction key. Further, a direction key input is informed, and at the same time, whether a currently input direction key is the left or right direction key or the upper or lower direction key is discriminated. For example, when the left or right direction key is input, a short vibration may be generated, and when the upper or lower direction key is input, a long vibration may be generated. As described above, the right direction key may be used to change a column and input a next braille. Accordingly, when an input of the right direction key for changing a column is sensed, a short vibration may be generated one time, and when an input of the right direction key for inputting next braille, a short vibration may be generated twice.

In step 313, the portable terminal determines whether a user input for inputting a second column is sensed. Herein, the portable terminal determines braille input by the user by using the braille input unit in which a position of a dot in the second column has been determined, in a state in which the position of the dot in the first column is determined. Namely, the portable terminal senses a key input used for changing the column for a dot selection. Herein, when a key input used to changing the column for a dot selection is sensed, the portable terminal may perform the input state notification process.

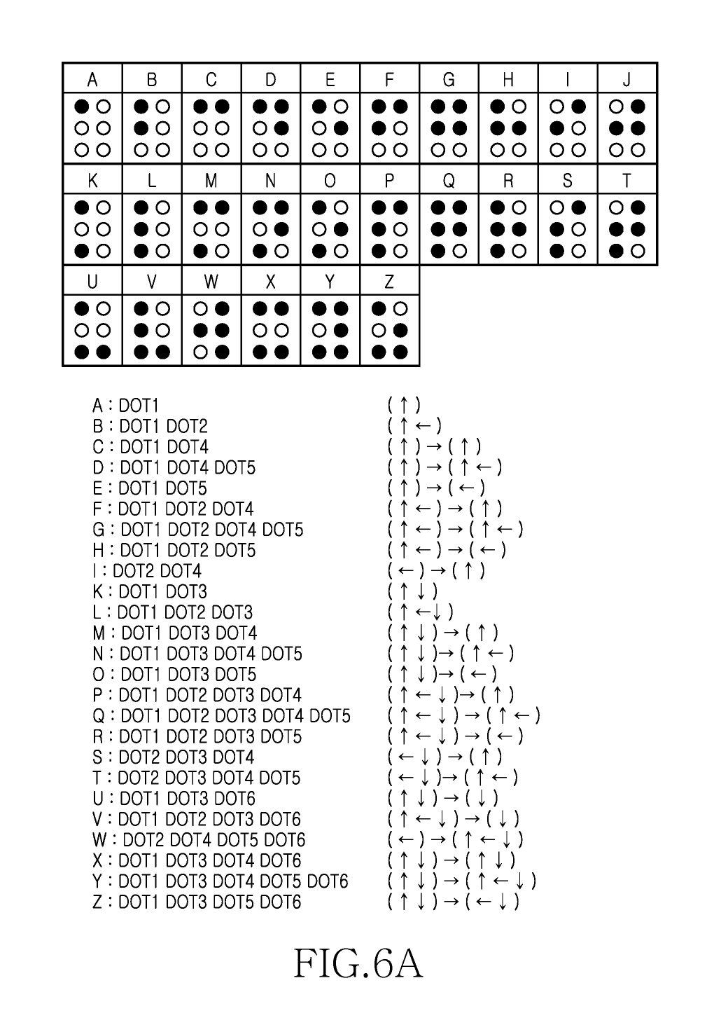

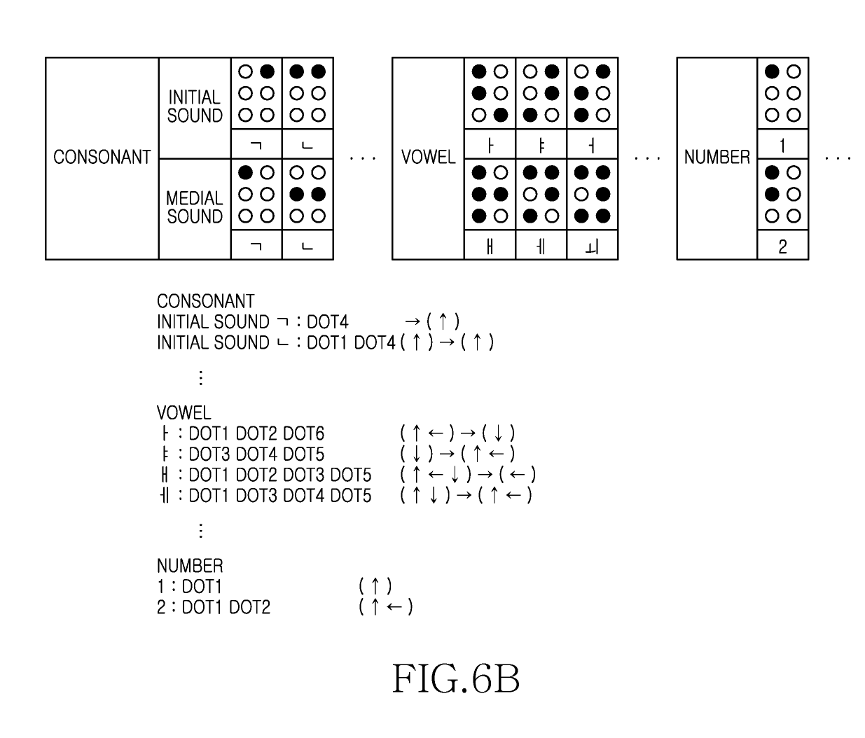

When a user input for inputting the second column is not sensed in step 313, the portable terminal returns to step 305. In this case, it is determined that there is no input for the second column. For example, “A” in FIG. 6A may be entered according to this route and the process returns to step 305 to check for another input.

However, when a user input for inputting the second column is sensed in step 313, the portable terminal determines in step 315 whether a direction key input for inputting braille is sensed.

Upon receiving an input of a direction key for inputting braille in step 315, the portable terminal checks a dot corresponding to the input direction key and inputs the checked dot to the second column of the braille input unit in step 317. When a plurality of direction keys may be input subsequently in step 317, the corresponding dots are checked and the checked dots are input to the second column according to direction keys.

In step 319, the portable terminal performs an input state notification process. Specifically, the portable terminal performs an input state notification process to inform the user about a position of the dot or positions of the dots selected. For example, the portable terminal may provide a number corresponding to the position of the selected dot or the positions of the selected dots by voice or vibration.

In step 321, the portable terminal determines whether character inputting has been completed.

When the character inputting has not been completed in step 321, the portable terminal returns to step 303 to continue to perform the character input process. However, when the character input has been completed, the portable terminal ends the method.

The method performed according to FIG. 3 may be provided as one or more instructions in one or more software modules stored in the storage unit. In that case, the software modules may be executed by the control unit 100.

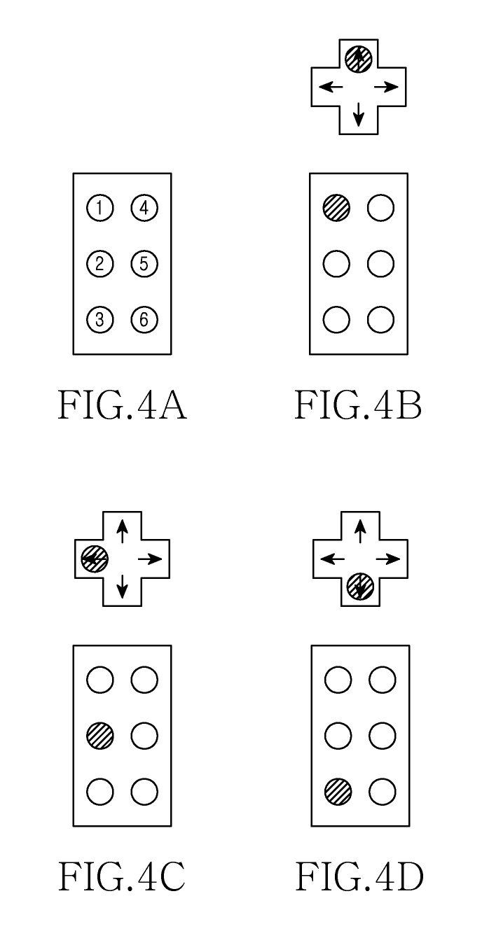

FIGS. 4A to 4D illustrate a sequential braille input process in a portable terminal according to an embodiment of the present invention.

Referring to FIG. 4A, the braille input unit checks user's braille inputting, which is a braille table including six dots. Thus, the portable terminal checks a position of a dot of the braille input unit determined according to a user input to check an input braille.

Each of the dots of the braille input unit are numbered, and the user may determine positions of the dots corresponding to braille by using an input button.

In addition, the dots of the braille input unit are divided into two columns, and the user may determine the positions of the dots in each column by using an input button and input braille.

When the direction key allowing for a movement up, down, left, and right is used as an input button for inputting braille, the portable terminal senses a button input allowing for the upward movement to determine the first dot in the first column as illustrated in FIG. 4B.

In addition, when the portable terminal senses a button input for leftward movement, the second dot in the first column is entered as illustrated in FIG. 4C. Similarly, when the portable terminal senses a button input for downward movement, the third dot in the first column is entered as illustrated in FIG. 4D.

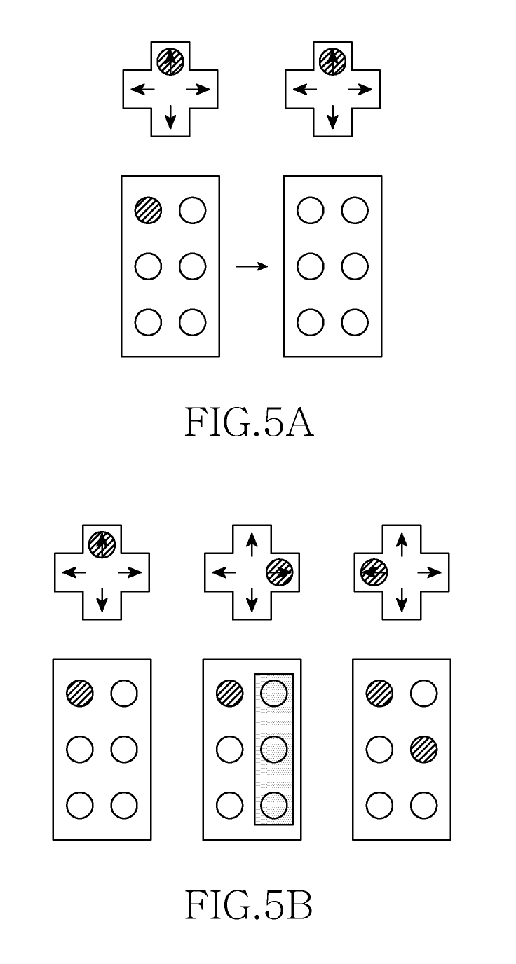

FIGS. 5A and 5B illustrating a process of inputting braille in a portable terminal according to an embodiment of the present invention.

Referring to FIG. 5, as described above, the portable terminal senses an input of the direction key to determine a dot position of the braille input unit. For example, when the portable terminal senses a button input for upward movement, the first dot in the first column is entered as illustrated in FIG. 5A.

At this time, the portable terminal notifies the user about the position of the dot corresponding to the button input by the user by voice or vibration, and the user may determine whether the button has been normally input through the notification.

When the user determines that the button has not been normally input, the user may delete the position of the previously input dot. In this case, the user may re-input the previously input button, and when the portable senses the input of the same button, the portable terminal may delete the dot of the previously input button from the braille input unit.

Alternatively, when the user wants to delete a previously inputted Braille or to cancel a braille input, the user may input a predetermined cancel button (e.g., a cancel button or an erase button) to delete or cancel the braille input.

Also, the portable terminal senses a button for changing a column for a dot selection to determine dot positions with respect to the second column.

Specifically, as illustrated in FIG. 5B, when a button input for the upward movement is sensed and the first dot is entered in the first column, and then a button input for rightward movement is sensed, the portable terminal shifts the column of the braille input unit to the second column.

Thereafter, when the portable terminal senses a button input for leftward movement, the second dot in the second column is entered.

In addition, the button for changing the column for a dot selection may be used as a key for a next braille input. Namely, a button input for changing a column for selecting a first dot may change the column from the first column to the second column, and a button input for changing a column for selecting a second dot may shift to one column of next braille.

FIG. 6A is a diagram illustrating a braille table corresponding to the English alphabet according to an embodiment of the present invention.

Referring to FIG. 6A, character data (or text data) corresponding to braille is generated using a braille table. For, a user enters braille corresponding “A: by entering a first dot in the first column in the braille table.

As described above, an up key (↑) for upward movement selects an upper dot in a first column or a second column, and a left key (←) for leftward movement selects a middle dot in the first column or the second column, a down key (↓) for downward movement selects a lower dot in the first column or the second column, and a right key (→) for rightward movement is used to change a column for a dot selection.

Accordingly, to enter “A”, the user inputs the up direction key (↑) to input the first dot in the first row, which corresponds “A”. When the user sequentially inputs the up and left direction keys (↑) and (←), dots are entered in the top and middle spot in the first column, which corresponds to “B”. Similarly, in order to input braille corresponding to “C”, the user inputs the up direction key (↑) to enter the top dot in the first column, followed by the column changing right key (→) to change to the second column, and then inputs the up direction key (↑) to enter the top dot in the second column.

FIG. 6B is a diagram illustrating a braille table corresponding to Hangul and numbers according to an embodiment of the present invention.

Referring to FIG. 6B, a braille table for entering braille character data corresponding to Hangul is illustrated. For example, when a first dot in the first column is displayed, this corresponds to a medial sound “ [symbol] ”.

In order to input braille corresponding to an initial consonant “ [symbol] ”, the user inputs the right key (→) to change from the first column to the second column and then inputs the up direction key (↑), in order to input the top dot in the second column (dot4).

Further, in order to input braille corresponding to a vowel “ [symbol] ”, the user inputs the direction up and left keys (↑) and (←) to input the top and middle dots in the first column, inputs the column changing right key (→) to change to the second the column, and then inputs the down direction key (↓) to input the bottom dot in the second column.

In addition, in order to input braille corresponding to number “1”, the user inputs the up direction key (↑) to enter the top dot in the first column.

As described above, a portable terminal according to an embodiment of the present invention expresses braille using direction keys to enter positions of dots and a column change command using the respective direction keys. This can be done using three direction keys for inputting the dots and one direction key for entering the column changing command, as described above, or may be performed using 6 keys, i.e., one for each dot.

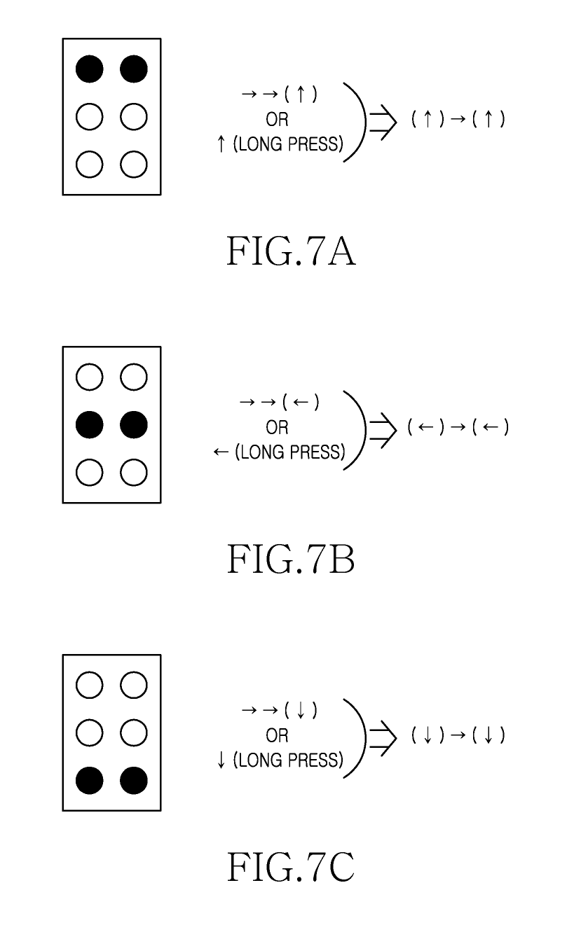

FIGS. 7A to 7C illustrate a process of inputting braille in a portable terminal according to an embodiment of the present invention.

Referring to FIGS. 7A to 7C, as described above, the portable terminal may input braille by using the six direction keys or input braille by using three direction keys for selecting positions of dots and one key for changing a column.

When all dots in the same row in the braille table including six dots are intended to be selected as shown in FIG. 7A, direction keys may be input as follows.

Namely, when inputting braille by using the six direction keys, i.e., one for each dot, in order to select the dots in the same row, the user should input buttons corresponding to 1 and 4, 2 and 5, or 3 and 6, as illustrated in FIG. 4A. Accordingly, in order to select all the dots arranged in a row, the user inputs the two direction keys.

When inputting braille by using four direction keys (i.e., three direction keys for selecting positions of dots and one key for changing a column in the braille table), the user select the positions of dots in the first column, changing the column, and then select positions of dots in the second column. Accordingly, in order to select all the dots arranged in a row, the user inputs the three direction keys, i.e., one to select the dot in the first column, the second to change columns, and the third to select the dot in the second column.

A portable terminal according to another embodiment of the present invention selects dots of a same row as follows.

First, the portable terminal may determine that dots in the same row are selected by using the direction key for changing a column.

In accordance with an embodiment of the present invention, when the direction key for changing a column is input once, the column for selecting the positions of dots is changed. However, when the direction key for changing a column is input twice, all dots included in the same row are selected, whereby all dots in the first row and all dots in the second row at the dot positions corresponding to the direction key input after the direction key for changing a column is input twice may be selected.

As illustrated in FIG. 7A, the upper dots in both the first and second columns are selected by inputting the right direction key (→) twice, i.e., (→)(→), and then inputting the up direction key (↑).

Alternatively, the upper dots in both the first and second columns are selected by when the up direction key (↑) is input for a long time, i.e., a long press. This simplifies the above described method in that only one key input is entered, instead of three.

In addition, as illustrated in FIG. 7B, the middle dots in both the first and second columns are selected by inputting the right direction key (→) twice, i.e., (→)(→), and then inputting the left direction key (←).

Alternatively, the middle dots in both the first and second columns are selected when the left direction key (←) is input for a long time, i.e., long press.

Further, as illustrated in FIG. 7C, the lower dots in both the first and second columns are selected by inputting the right direction key (→) twice, i.e., (→)(→), and then inputting the down direction key (↓).

Alternatively, the lower dots in both the first and second columns are selected when the down direction key (↓) is input for a long time, i.e., a long press.

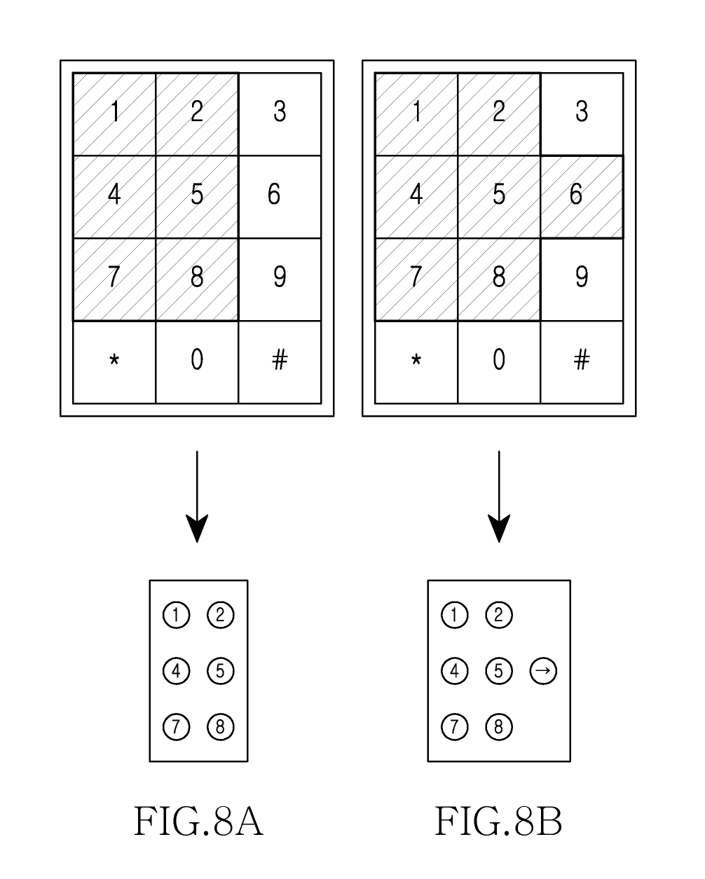

FIGS. 8A and 8B illustrating a process of inputting braille in a portable terminal according to an embodiment of the present invention. Specifically, in FIGS. 8A and 8B, the portable terminal selects respective dots in the braille table by using six direction keys.

Referring to FIG. 8A, a first dot in the first column in the braille table is selected by using a direction key 1, a first dot in the second column in the braille table is selected by using a direction key 2, second and third dots of the first column in the braille table are selected by using the direction keys 4 and 7, respectively, and the second and third dots in the second column in the braille table are selected by using direction keys 5 and 8, respectively.

Herein, when a direction key for selecting a dot in the first column is successively input upon selecting a direction key for selecting a dot in the second column, inputting of a character is completed and a next character may be successively input in the portable terminal.

Referring to FIG. 8B, the portable selects respective dots in the braille table by using the six direction keys and utilizes a separate key for completing character inputting. Specifically, the dots in the braille table are selected as described above for FIG. 8A. However, the character input is completed by using a direction key 6, such that a next character may be successively input.

It will be appreciated that embodiments of the present invention according to the claims and description in the specification can be realized in the form of hardware, or a combination of hardware and software.

Any such software may be stored in a computer readable storage medium. The computer readable storage medium stores one or more programs (software modules), the one or more programs comprising instructions, which when executed by one or more processors in an electronic device, cause the electronic device to perform a method of the present invention.

Any such software may be stored in the form of volatile or non-volatile storage such as, for example, a storage device like a ROM, or in the form of memory such as, for example, RAM, memory chips, device or integrated circuits or on an optically or magnetically readable medium such as, for example, a Compact Disc (CD), a Digital Versatile Disc (DVD), a magnetic disk, magnetic tape, etc. It will be appreciated that the storage devices and storage media are embodiments of machine-readable storage that are suitable for storing a program or programs comprising instructions that, when executed, implement embodiments of the present invention.

Accordingly, embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

As described above, the present invention improves braille input performance in a portable terminal. Accordingly, a user can easily input braille by selecting dot positions in the braille table by using direction keys.

While the present invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. An apparatus for inputting braille in a portable terminal, comprising:
an input unit for receiving an input from a user; and
a control unit for determining a dot position of a braille input unit based on the input from the user.

2. The apparatus of claim 1, wherein the control unit notifies information on the determined dot position using at least one of voice generation and vibration generation.

3. The apparatus of claim 1, wherein the braille input unit comprises a braille table including six dots for expressing characters, and
wherein the six dots are arranged in two columns and each of the two columns includes three of the six dots.

4. The apparatus of claim 3, wherein the input from the user comprises at least one of an input for selecting an upper dot, an input for selecting a middle dot, an input for selecting a lower dot, and an input for changing between the two columns.

5. The apparatus of claim 4, wherein the control unit deletes a selected dot in a corresponding position when another input for selecting the selected dot is input before an input for changing a column is sensed.

6. The apparatus of claim 4, wherein the controller senses an input for selecting dots in a same position of the two columns and determines same dot positions in the two columns.

7. The apparatus of claim 3, wherein the input button corresponds to a dot position of the braille table.

8. The apparatus of claim 3, wherein the input button corresponds a dot position of the braille table, and
wherein input unit further includes an input button for completing character inputting.

9. A method for inputting braille in a portable terminal, comprising:
receiving an input from a user; and
determining a dot position of a braille input unit, based on the input from the user.

10. The method of claim 9, further comprising notifying information on the determined dot position using at least one of voice generation and vibration generation.

11. The method of claim 9, wherein the braille input unit includes a braille table including six dots for expressing characters, and
wherein the six dots are arranged in two columns and each of the two columns includes three of the six dots.

12. The method of claim 11, wherein the input from the user includes at least one of an input for selecting an upper dot, an input for a middle dot, an input for a lower dot, and an input for changing between the two columns.

13. The method of claim 12, wherein determining the dot position of the braille input unit comprises:
sensing an input for selecting a dot in a first column of the two columns;
sensing an input for changing from the first column to a second column of the two columns;
changing to the second column; and
sensing an input for selecting a dot in the second column.

14. The method of claim 12, wherein determining the dot position of the braille input unit comprises deleting a selected dot in a corresponding position when another input for selecting the selected dot is input before an input for changing a column is sensed.

15. The method of claim 12, wherein determining the dot position of the braille input unit comprises:
sensing an input for selecting dots in a same position of the two columns; and
determining same dot positions in two columns.

16. The method of claim 12, wherein determining the dot position of the braille input unit comprises:
sensing successive inputs for determining dot positions in the braille input unit; and
determining a dot positions in at least on of the two columns, based on the successive inputs.

17. The method of claim 11, wherein the input from the user is received via an input button to which a dot position of the braille input unit is mapped.

18. The method of claim 11, wherein the input from the user is received via an input button to which a dot position of the braille input unit is mapped and a button for completing character inputting.

19. An electronic device for inputting braille comprising a non-transitory machine-readable medium storing one or more programs which when executed implement the steps of:
receiving an input from a user; and
determining a dot position of a braille input based on the input from the user.

20. The electronic device of claim 19, wherein the braille input unit includes a braille table including six dots for expressing characters, and
wherein the six dots are arranged in two columns and each of the two columns includes three of the six dots.
